(19) United States
(12) Patent Application Publication
(10) Pub. No.: US 2003/0082369 A1
(43) Pub. Date: May 1, 2003

(54) Insulation facing material

(76) Inventors: William R. Arndt, Hilbert, WI (US); Michael R. Nowak, Hilbert, WI (US); LouAnn S. Mueller, Little Chute, WI (US)

Correspondence Address: Philip M. Weiss, WEISS & WEISS, 500 OLD COUNTRY ROAD, GARDEN CITY, NY, 11530, US

(21) Appl. No.: 10/021,184

(22) Filed: Oct. 30, 2001

(51) Int. Cl. B32B 5/02

(52) U.S. Cl. 428/340; 156/244.11; 428/537.5

(57) ABSTRACT

A composite coextruded material for use in facing insulation rolls or batts and other materials. The facing material comprises a layer of paper and two polymer resin layers. The present invention further comprises a method of making and using the insulation facing material.

### FIELD OF THE INVENTION

The present invention relates to insulation facing materials for use as a protective moisture barrier facing sheet (vapor retarding facing) for fiberglass and other home and commercial insulation batting used in walls and ceiling applications, and methods of making the barrier facing sheet. More particularly, the invention relates to composite coextrusion facing materials used for fiberglass, and other possible types of insulation.

### BACKGROUND OF THE INVENTION

Rolls and batts of composite facing are used by most fiberglass and other insulation manufactures to provide a moisture barrier facing and carrier sheet for adhering the insulation to ceilings and walls of commercial buildings and residential homes. These batts and rolls can be found in retail stores packaged in various widths and lengths for consumer purchase, however the majority of this material is sold through distributors to installers. In addition to supporting the fiberglass and other insulation materials for installation, the facing provides a moisture barrier and is printed with the R (heat resistance) factor and other information. The physical strength of the facing is important as well, so as to support the weight of the insulation during installation process, normally stapled inside the wall cavities, so as not to allow tearing to maintain the integrity of the moisture barrier. The facing provides a barrier that prevents moisture from the warmer building from condensing into the insulation and rendering it less effective.

Conventional home and commercial facing include paper/polyethylene or paper/asphalt and foil combinations that are usually printed and flanged in rolls or folded batts. A drawback of the polyethylene coated facing paper can be the low burst/tear strength. This occurs when the product is manufactured at the minimum polyethylene coatings weights to meet moisture barrier requirements. Oftentimes installers complain about the product ripping or tearing during installation. It is not cost effective to apply heavy polyethylene coatings. Higher polyethylene weights also create a thicker product reducing the amount of material that can be put on a roll causing additional roll changes during manufacturing and freight cost inefficiencies.

U.S. Pat. No. 5,922,626 relates to a self-adhering tape-like or fibrous reinforcing material which consists of laminates of at least two or more coextruded layers of at least one high-temperature stable plastic material (A) and at least one low-melting plastic material (B). The low-melting plastic material (B) has self-adhering binder properties whereas the high-temperature stable plastic material (A) is suitable for conferring increased strength properties to nonwoven textile fabrics, in particular in the automobile area.

U.S. Pat. No. 5,746,854 relates to a method of manufacturing/making mineral fiber (e.g. fiberglass) thermal insulation batt wherein a base mineral fiber layer is impregnated with a two-layer layering system so as to produce a batt which is substantially vapor impermeable with a perm vapor rating less than about one. The first layer of the layering system is of a low melt material while the second layer is of a high melt material, the first layer being sandwiched between the base insulating layer, and functioning to bond the layering system to the base.

U.S. Pat. No. 5,733,624 relates to a mineral fiber (e.g. fiberglass) thermal insulation batt wherein a base mineral fiber layer is impregnated with a two-layer layering system so as to produce a batt which is substantially vapor impermeable with a perm vapor rating less than about one. The first layer of the layering system is of a low melt material while the second layer is of a high melt material, the first layer being sandwiched between the base insulating layer and the second layer, and functioning to bond the layering system to the base. This patent relates to a coex film of low density resin with EVA and high density. This product is coextruded right onto the fiberglass batt in-line. It is referred to as impregnated right into the fiberglass.

U.S. Pat. No. 6,191,057 relates to a facing system for an insulation product. An insulation product includes an elongated batt of fibrous insulation material, and a facing adhered to a major surface of the batt, wherein the facing is a coextruded polymer film of barrier and bonding layers. The bonding layer has a softening point lower than the softening point of the barrier layer and the bonding layer being one or more materials of the group consisting of ethylene N-butyl acrylate, ethylene methyl acrylate and ethylene ethyl acrylate, and wherein the facing has been heated to a temperature above the softening point of the bonding layer, but below the softening point of the barrier layer, whereby the facing is adhered to the batt by the attachment of the bonding layer to the fibers in the batt due to the softening of the bonding layer.

### SUMMARY OF THE INVENTION

The present invention relates to a coextruded coated paper material comprising; a first layer composed of paper; a second layer composed of a polymer resin material; and a third outside sealant layer of low melt polymer resin; wherein all three layers are integrally bonded together. It is an object of the present invention for the polymer resin layer to provide a moisture vapor barrier and improved strength to the coextruded material. It is an object of the present invention for the third layer to provide an adhesion or bond to the insulation. It is an object of the present invention for the first, second and third layers to be continuously bonded together such that there are substantially no air pockets in between. Substantially no air pockets is defined as less than about three air pockets in approximately ten square feet of the coextruded material.

It is an object of the present invention for the first layer to comprise cellulosic material having a basis weight of about 35-55 lbs./3,000 sq. ft. It is an object of the present invention for the first layer to comprise a cellulosic material having fold retention. Fold retention is defined as the ability to maintain a crease. It is an object of the present invention for the first layer of the coextruded material to be composed of a primed or unprimed cellulosic material selected from the group consisting of machine finished paper, machine glazed paper or extensible paper. It is an object of the present invention for the second layer of the coextruded material to comprise a polymer resin selected from the group consisting of high density polyethylene, polypropylene or linear low density polyethylene. It is an object of the present invention for the third layer of the coextruded material to comprise a polymer resin material selected from the group consisting of low density, high melt index polyethylene that can be flame or corona (electrically) treated to enhance adhesion or bonding to fiberglass or other insulation. It is an object of the present invention for one or more of the layers of the coextruded material to be pigmented.

It is an object of the present invention for the coextruded material to be faced with a roll or batt of insulation. It is an object of the present invention for the coextruded material to provide a barrier to effectively prevent moisture absorption into the insulation.

It is an object of the present invention for the coextruded material to have a burst strength value of approximately 60 or greater. It is an object of the present invention for the coextruded material to have a WVTR value of approximately 0.50 or less.

The present invention relates to a process for making a composite material comprising: providing a first sheet of cellulosic material and a second coextruded layer comprising two layers of polymer resin materials. The coextrusion layers are applied to the surface of the first sheet. The first sheet and the second coextrusion layers are conveyed into a laminating apparatus where the layers are bonded to form an integral composite material.

The present invention relates to co-extrusion of ethylene based materials to be part of a paper substrate structure used for insulation facing. Fiberglass and other insulating type materials are incorporated with the coextruded substrate, laminated to the ethylene surface to form a composite product used in the building industry. The paper substrate has a release characteristic which during the process of creating the coextruded material does not stick to the drum like film. The paper substrate provides strength and rigidity to the product. Further paper does not melt.

It is an object of the present invention to provide a thin, high strength, moisture barrier coating that address the installers concerns for tear strength, and allows maximum footage at normal roll diameters and meets or exceeds the moisture barrier specifications. These results can be measured by burst testing, MVTR (moisture vapor transmission rates) and actual roll diameters versus footage on the roll.

The coextrusion process of the present invention comprises applying two different resins, simultaneously, to one side of a paper. One resin has a high strength (burst values at approximately 60 or greater versus with a single layer LPDE of comparable thickness), and low moisture transmission rates (WVTR test values of 0.50 or less versus 1.00 with a single LPDE layer of comparable thickness). The other layer provides the low temperature (100 degrees C. or less) seal strength required for good adherence to fiberglass or other insulation product. This composite coextruded product provides the desired improvements at the same or lower cost to the fiberglass or other insulation producer.

The coextrusion layers of the invention can be composed of either a layer of polypropylene homopolymer or copolymer, high density polyethylene or linear low density polyethylene all of which provide higher strength (Burst values at 60 or greater versus 30 with a single layer LPDE of comparable thickness), and lower moisture vapor transmission rates (WVTR test values of 0.50 or less versus 1.00 with a single LPDE layer of comparable thickness). The outer coex layer is a high melt index (approximately 10.0 melt index or higher) low density polyethylene providing improved bond (visual pulling away of fiberglass strands when separated) or adhesion to the fiberglass or other insulation product.

### BRIEF DESCRIPTION OF THE DRAWINGS

FIG. 1 is a cross-sectional view of the coextrusion layer as applied to paper.

FIG. 2 is a schematic view of an apparatus used to produce the coextrusion material of FIG. 1.

### DETAILED DESCRIPTION OF THE INVENTION

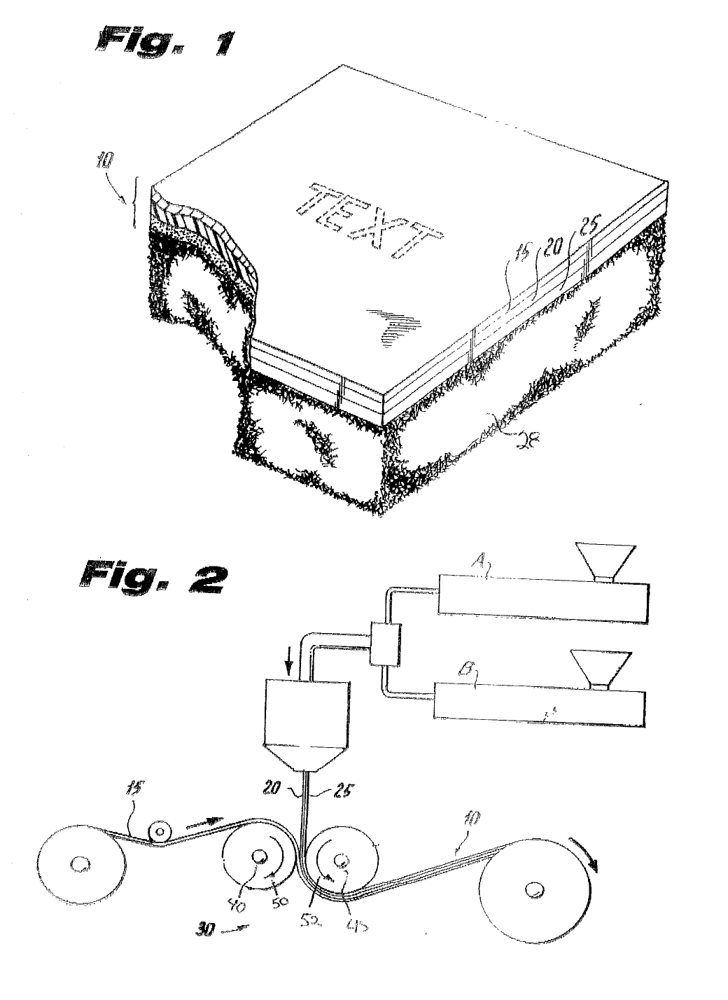

FIG. 1 shows an embodiment of the coextrusion material of the present invention. The composite wrap material 10 is made of a first layer 15 composed of a cellulosic material, a layer 20 composed of a polymer film material, and a second polymer layer 25 positioned on top of the first layer. The wrap material 10 is attached to fiberglass or other insulation 28. The composite wrap material 10 has increased strength (Burst values 60 or greater versus 30 with a single layer LPDE of comparable thickness) compared to conventional materials, and is particularly effective in improving physical strength (puncture resistance) and decreasing moisture transmission rates.

The first layer 15 of the wrap material 10 can be made of any material composed primarily of cellulosic fibers. Suitable materials for use as the first layer 15 include, for example, machine-finished or machine-glazed paper, extensible paper or other types of paper. An exemplary material for the first layer 15 is paper with a burst strength of 50 to 60 and a basis weight of about 35-55 lbs. per 3,000 sq. ft.

The initial inside layer 20 of the coextrusion material 10 is a polymer resin that, when applied to the first layer 15 increases the overall composite strength (burst) and provides a high moisture barrier (0.50 WVTR or less)/low moisture transmission rate, over the first layer 15. Such polymer resins include: polypropylene homopolymers and copolymers, high density polyethylenes and linear low density polyethylenes.

A low density polyethylene having a high melt index (10.0 or higher) is used for the sealant layer 25 (outside layer) or second layer.

Optionally, one or more of the two coextrusion layers, 20, 25 can include a coloring agent to provide a transparent, or an opaque colored material to enhance the appearance. Coloring agents that impart opacity include, for example, inorganic pigments, such as titanium dioxide or barium sulfate (white), a metallic oxide pigment such as an iron oxide, zinc oxide or chromium oxide greens, ultramarine pigments, cadmium pigments and carbon black, among others.

In use, the paper/coextrusion material is heated and the polymer side is placed next to the fiberglass or other insulation so as to allow the outside, low density polyethylene to adhere to the insulation. The other side of the wrap material may be printed upon using known printing techniques.

The densities of the paper layer 15 and the polymer film layer 20 of the composite wrap material 10 can be varied to control the performance of the final structure.

In a preferred embodiment, material 10 can be prepared by coextrusion, extrusion or adhesive lamination or coating as schematically depicted in FIG. 2. The laminating device 30 includes two nip rollers 40, 45, that rotate in opposite directions, as shown by arrows 50, 52. In a typical set-up, the surface temperature of the chill roll 45 is controlled for cooling the adhesives 20, 25. During this same process the outside of the sealant layer can also be flame or corona (electrically) treated to enhance adhesion or bonding to the fiberglass or other insulation.

The invention has been described by reference to detailed examples. These examples are not meant to limit the scope of the invention. Variations within the concepts of the invention are apparent to those skilled in the art. The disclosures of the cited references throughout the application are incorporated by reference herein.

1. A coextruded coated paper material comprising;
a first layer comprising paper;
a second layer comprising a polymer resin material; and
a third outside sealant layer of high melt index polymer resin;
wherein all three layers are integrally bonded together.

2. The coextruded material of claim 1 wherein said polymer resin layer provides a moisture vapor barrier and improved strength.

3. The coextruded material of claim 1 wherein said third layer provides adhesion or bond to insulation.

4. The coextruded material of claim 1, wherein said first, second and third layers are continuously bonded together such that there are substantially no air pockets in between.

5. The coextruded material of claim 1 wherein the first layer comprises cellulosic material having a basis weight of about 35-55 lbs./3,000 sq. ft.

6. The coextruded material of claim 1, wherein the first layer comprises a cellulosic material having fold retention.

7. The coextruded material of claim 1, wherein said first layer comprises a cellulosic material selected from the group consisting of machine finished paper, machine glazed paper or extensible paper.

8. The coextruded material of claim 1, wherein the second layer comprises a polymer resin selected from the group consisting of high density polyethylene, polypropylene or linear low density polyethylene.

9. The coextruded material of claim 1 wherein the third layer comprises a polymer resin material which is a low density, high melt index polyethylene that can be flame or corona (electrically) treated to enhance adhesion or bonding to fiberglass or other insulation.

10. The coextruded material of claim 1 wherein one or more of said layers are pigmented.

11. The coextruded material of claim 1 wherein said material is faced with a roll or batt of insulation.

12. The coextruded material of claim 1 wherein said material has a burst strength value of approximately 60 or greater.

13. The coextruded material of claim 1 wherein said material has WVTR value of approximately 0.50 or less.

14. The coextruded material of claim 11 wherein said material provides a barrier to effectively prevent moisture absorption into said insulation.

15. The coextruded material of claim 1 wherein said paper has a release characteristic.

16. A process for making a composite material comprising:
providing a first sheet of cellulosic material and a second coextruded layer comprising two layers of polymer resin materials;
applying the coextrusion layers to a surface of said first sheet;
conveying said first sheet and said second coextrusion layer into a laminating apparatus and bonding said layers to form an integral composite material.
